(19) United States
(12) Patent Application Publication
(10) Pub. No.: US 2008/0278458 A1
(43) Pub. Date: Nov. 13, 2008

(54) LIQUID CRYSTAL DEVICE AND ELECTRONIC APPARATUS

(75) Inventors: Akinori Masuzawa, Suwa-Shi (JP); Eiji Kanda, Suwa-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: SEIKO EPSON CORPORATION, Shinjuku-ku (JP)

(21) Appl. No.: 12/115,873

(22) Filed: May 6, 2008

(30) Foreign Application Priority Data
May 8, 2007 (JP) 2007-123355

(51) Int. Cl. G06F 3/044

(52) U.S. Cl. 345/174

(57) ABSTRACT

Provided a liquid crystal device including a liquid crystal layer interposed between a pair of substrates, the liquid crystal device including: pixel electrodes which are arranged in an image display area, for displaying an image; sensor electrodes which detect a variation in capacitance of the liquid crystal layer; and cylindrical structures which maintain a gap between the pair of substrates and are arranged so as not to two-dimensionally overlap each other.

### BACKGROUND

1. Technical Field

The present invention relates to a liquid crystal device and an electronic apparatus.

2. Related Art

A touch panel is an auxiliary input device of a display unit (electro-optical device) of an electronic apparatus such as a personal computer or a personal digital assistant (PDA) and instructs the input of data required by the electronic apparatus by touching a finger of an operator or a pen on the surface of a panel at a desired position.

A known liquid crystal touch panel electrically detects a variation in capacitance of a liquid crystal layer which occurs by pressing a substrate and detects a press position of the substrate. As such a touch panel, for example, there are a device (see JP-A-2001-100916) which has a liquid crystal layer made of cholesteric liquid crystal and electrically detects a variation in alignment state of liquid crystal, which occurs by pressing a substrate, through a pair of electrodes, a device (see JP-A-2001-75074) for bringing respective touch electrodes of a pair of substrates into contact with each other by pressing a substrate so as to detect a touch position and a device (see JP-A-11-271712) which includes a pressure detection element provided in a spacer for defining a cell thickness and detects a touch position by detecting stress applied to the spacer by pressing a substrate using the pressure detection element.

In JP-A-2001-100916, since the cholesteric liquid crystal is used, it is possible to measure the display and the capacitance of the display pixels. However, the variation in liquid crystal capacitance may not be detected according to the display image. Since it is difficult to vary the liquid crystal capacitance in the vicinities of cylindrical structures even when the substrate is pressed, the variation in capacitance may vary and thus position detection precision is susceptible to deteriorate, but a method of arranging the cylindrical structures is not described. In a case where the number of cylindrical structures is increased as the number of pixels is increased, low temperature foaming is susceptible to be generated.

In JP-A-2001-75074, since a convex member is formed below the touch electrode, the touch electrodes can be brought into contact with each other by low pressing force. However, the cell thickness narrows at a low temperature due to the temperature characteristics (thermal expansion coefficient) of the liquid crystal and thus the electrodes may be brought into contact with each other. In contrast, at a high temperature, the cell thickness thickens and thus the electrodes cannot be brought into contact with each other with certainty.

In JP-A-11-271712 and JP-A-2001-183630, since the pressure detection element and the spacer need to be arranged at the same position, the same problem as JP-A-2001-75074 occurs due to the temperature characteristics of the liquid crystal. In JP-A-2001-183630, pressure detection element and the spacer do not need to be arranged at the same position, but the pressure detection element of the pressing unit cannot be pressed with certainty. Accordingly, it is impossible to substantially detect the touch position.

In JP-A-2001-75074, JP-A-11-271712 and JP-A-2001-183630, there is a limitation in the shapes, the arrangement positions and the number of the members, in order to use the device in a wide temperature range. If the specification of the panel is changed, the pressure may not be detected.

There is a need for a device for solving the above-described problems and accurately detecting a press position in an image display area.

### SUMMARY

An advantage of some aspects of the invention is that it provides a liquid crystal device and an electronic apparatus, which are capable of preventing damage due to pressing force and accurately detecting a press position in an image display area.

According to an aspect of the invention, there is provided a liquid crystal device including a liquid crystal layer interposed between a pair of substrates, the liquid crystal device including: pixel electrodes which are arranged in an image display area, for displaying an image; sensor electrodes which detect a variation in capacitance of the liquid crystal layer; and cylindrical structures which maintain a gap between the pair of substrates and are arranged so as not to two-dimensionally overlap each other.

According to the liquid crystal device of the invention, since the sensor electrodes for detecting the variation in capacitance of the liquid crystal layer are provided independent of electrodes for image display (pixel electrodes), it is possible to measure the variation in capacitance of the liquid crystal layer with certainty, without being influenced by a display image. Accordingly, it is possible to accurately detect a touch position of a user in the image display area. In addition, it is possible to prevent the pixel electrodes or the sensor electrodes from being damaged by the cylindrical structures, due to the pressing force of the user. Since the sensor electrodes and the cylindrical structures are separated from each other, it is possible to suppress unevenness of the input of a press portion.

In a unit area of the image display area, the number of cylindrical structures may be equal to the number of sensor electrodes and the sensor electrodes may be at the same distance from at least two cylindrical structures nearest to the sensor electrodes.

According to this configuration, since the distance between the cylindrical structures and the sensor electrodes is constant, if the same pressing force is applied, the cell thicknesses of all the sensor electrodes equally vary. Accordingly, unevenness does not occur in the variation in capacitance and a touch position can be detected with certainty.

In a unit area of the image display area, the number of sensor electrodes may be larger than the number of cylindrical structures and the cylindrical structures may be at the same distance from at least two sensor electrodes nearest to the cylindrical structures.

According to this configuration, since the distance between the cylindrical structures and the sensor electrodes is constant, if the same pressing force is applied, the cell thicknesses of all the sensor electrodes vary by at least a predetermined value. If a predetermined variation in capacitance occurs, it is possible to detect the touch position with certainty. The number of cylindrical structures can be adequately set such that the uniformity of the cell thickness is ensured and low temperature foaming is prevented.

Protrusions having a height lower than that of the cylindrical structures may be provided in the image display area and the protrusion, the pixel electrodes, the sensor electrodes and the cylindrical structure may be arranged so as not to two-dimensionally overlap one another.

According to this configuration, since the protrusions having the height lower than that of the cylindrical structure are included, it is possible to prevent the substrates from being brought into contact with the pressing force of the user. Accordingly, it is possible to prevent the pixel electrodes and the sensor electrode from being damaged and maintain touch position detection precision.

In a unit area of the image display area, the protrusions may be at the same distance from at least two cylindrical structures nearest to the protrusions.

According to this configuration, since the arrangement interval between the cylindrical structures and the protrusions is constant, it is possible to prevent the substrates from being brought into contact with each other at every position of the image display area.

The cylindrical structures and the protrusions may be formed of the same material.

According to this configuration, since the cylindrical structures and the protrusions can be simultaneously formed, it is possible to prevent the increase of cost.

A planarization film may be provided on any one of the pair of substrates, the cylindrical structures may be arranged on the planarization film, and the protrusions may be arranged in concave portions provided in the planarization film.

According to this configuration, the heights of the cylindrical structures and the protrusions formed on the substrate are different from each other. Accordingly, even when the protrusions are formed so as to have the same structure using the same mask as the cylindrical structures, it is possible to obtain the protrusions having the height lower than that of the cylindrical structures. Accordingly, it is possible to improve product yield and prevent the increase of cost.

The sensor electrodes, the cylindrical structures and the protrusions may be regularly and selectively arranged in an arrangement direction of pixels.

According to this configuration, since the sensor electrodes, the cylindrical structures and the protrusions may be regularly and selectively arranged in the arrangement direction of the pixels, it is possible to prevent the substrate from being brought into contact with each other and accurately detect the variation in capacitance of the liquid crystal layer.

An interval between the sensor electrodes and an interval between the cylindrical structures may be equal to or greater than a pixel pitch.

According to this configuration, although any one of the sensor electrodes, the cylindrical structures and the protrusions is not included in all the pixels of the image display area, it is possible to accurately detect the touch position of the user in the image display area.

The sensor electrodes and the cylindrical structures may be alternately arranged in a row direction and a column direction of pixels.

According to this configuration, since the arrangement interval between the sensor electrodes and the cylindrical structures in the image display area is constant, it is possible to detect the variation in capacitance of the liquid crystal layer with certainty, and accurately detect the touch position of the user in the image display area.

The sensor electrodes and the cylindrical structures may be alternately arranged in any one of a row direction and a column direction of pixels, and the sensor electrodes and the protrusions may be alternately arranged in the other one of the row direction and the column direction of the pixels.

According to this configuration, since the arrangement interval between the sensor electrodes and the cylindrical structures and the arrangement interval between the sensor electrodes and the protrusions are constant, it is possible to prevent the substrates from being brought into contact with each other, detect the variation in capacitance of the liquid crystal layer with certainty, and accurately detect the touch position of the user in the image display area.

According to another aspect of the invention, there is provided an electronic apparatus comprising the above-described liquid crystal device.

According to this configuration, since an electro-optical device capable of accurately determining touch without complicating the configuration of the device is included, it is possible to obtain a product with improved reliability and high capability.

### BRIEF DESCRIPTION OF THE DRAWINGS

The invention will be described with reference to the accompanying drawings, wherein like numbers reference like elements.

FIG. 1 is a plan view showing the whole configuration of a liquid crystal device according to a first embodiment of the invention.

FIG. 2 is a cross-sectional view taken along line II-II of FIG. 1.

FIG. 3 is an equivalent circuit diagram showing the liquid crystal device according to the first embodiment of the invention.

FIG. 4 is a schematic plan view showing a portion of a pixel arrangement on a device substrate.

FIG. 5 is a cross-sectional view taken along line V-V of FIG. 4.

FIG. 6 is a plan view showing the whole configuration of a liquid crystal device according to a second embodiment of the invention.

FIG. 7 is a plan view showing the whole configuration of a liquid crystal device according to a third embodiment of the invention.

FIG. 8 is a plan view showing the whole configuration of a liquid crystal device according to a fourth embodiment of the invention.

FIG. 9 is a cross-sectional view taken along line IX-IX of FIG. 8.

FIG. 10 is a view showing a method of manufacturing a protrusion.

FIG. 11 is a schematic view of a projector which is an example of an electronic apparatus.

### DESCRIPTION OF EXEMPLARY EMBODIMENTS

Hereinafter, embodiments of the invention will be described with reference to the accompanying drawings. In each view used for following description, the scale of each layer or each element is differentiated from others in order that each layer or each element has a size capable of being identified in the view.

### First Embodiment

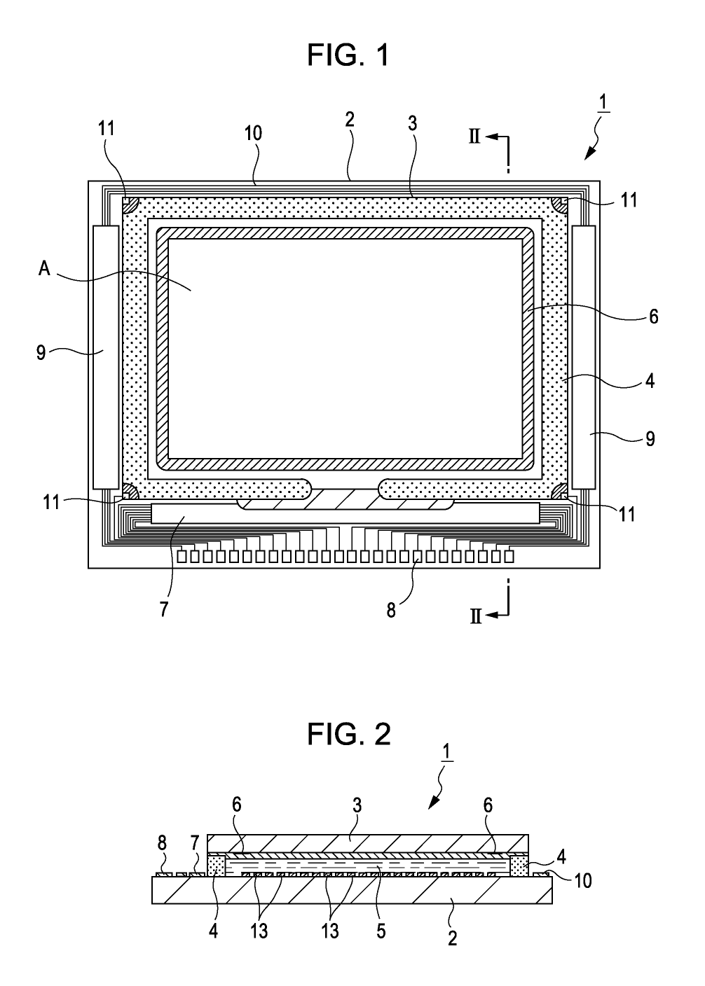

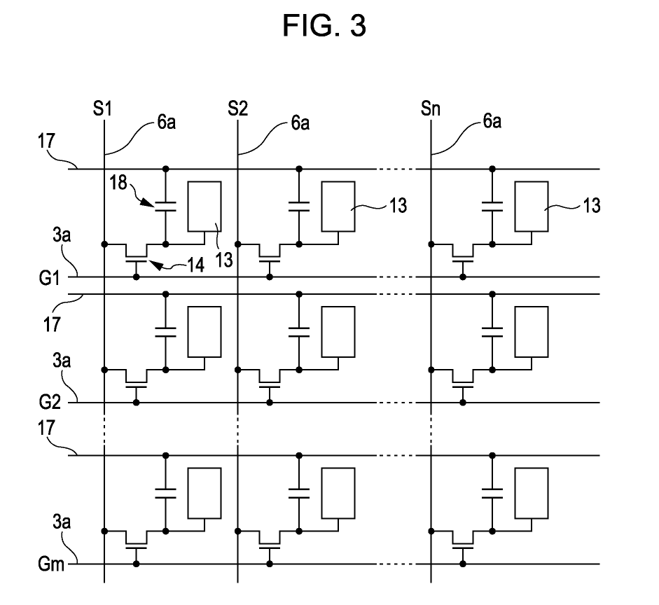

FIG. 1 is a plan view showing the whole configuration of a liquid crystal device according to a first embodiment of the invention. FIG. 2 is a cross-sectional view taken along line II-II of FIG. 1. FIG. 3 is an equivalent circuit diagram showing the liquid crystal device.

As shown in FIGS. 1 and 2, in the liquid crystal device 1 according to the present embodiment, a device substrate 2 and a counter substrate 3 are attached to each other by a seal material 4 and a liquid crystal layer 5 is sealed in an area partitioned by the seal material 4. The liquid crystal layer 5 is made of a liquid crystal material having positive dielectric anisotropy. A light-shielding material 6 made of a light-shielding material is formed in the inner area of the area in which the seal material 4 is formed. In a peripheral circuit area located at the outside of the seal material 4, a data line driving circuit 7 and an external circuit mounting terminal 8 are formed along one side of the device substrate 2 and scan line driving circuits 9 are formed along two sides adjacent to the side. A plurality of lines 10 for connecting between the scan line driving circuits 9 provided at the both sides of a display area is provided along one remaining side of the device substrate 2. Conductive materials 11 for electrically connecting the device substrate 2 and the counter substrate 3 are provided at corners of the counter substrate 3.

FIG. 3 is an equivalent circuit diagram showing the liquid crystal device according to the present embodiment. Pixel electrodes 13 are respectively formed in a plurality of pixels which are arranged in a matrix for configuring an image display area A (see FIG. 1) of the liquid crystal device 1. TFTs 14 which are pixel switching elements for controlling the supply of power to the pixel electrodes 13 are respectively formed on the side of the pixel electrodes 13. Data lines 6a are electrically connected to the sources of the TFTs 14. Image signals S1, S2, . . . , and Sn are supplied to the data lines 6a, respectively. The image signals S1, S2, . . . , and Sn may be supplied to the data lines 6a in line sequence or may be supplied to each group of the plurality of adjacent data lines 6a.

Scan lines 3a are electrically connected to the gates of the TFTs 14. Scan signals G1, G2, . . . , and Gm are supplied to the scan lines 3a at predetermined timings in a pulsed manner. The scan signals G1, G2, . . . , and Gm are applied to the scan lines 3a in line sequence.

The pixel electrodes 13 are electrically connected to the drains of the TFTs 14. When the TFTs 14 which are the switching elements are turned on by the scan signals G1, G2, . . . , and Gm supplied from the scan lines 3a in a predetermined period, the image signals S1, S2, . . . , and Sn supplied from the data lines 6a are written in the liquid crystal of the pixels at predetermined timings.

The image signals S1, S2, . . . , and Sn written in the liquid crystal are held by liquid crystal capacitances between the pixel electrodes 13 and counter electrodes in a predetermined period. In order to prevent the leakage of the held image signals S1, S2, . . . , and Sn, storage capacitors 18 are formed between the pixel electrodes 13 and capacitive lines 17 and are arranged in parallel to the liquid crystal capacitance. When a voltage signal is applied to the liquid crystal, the alignment state of the liquid crystal molecules varies by the applied voltage level.

### Detailed Configuration of Liquid Crystal Device

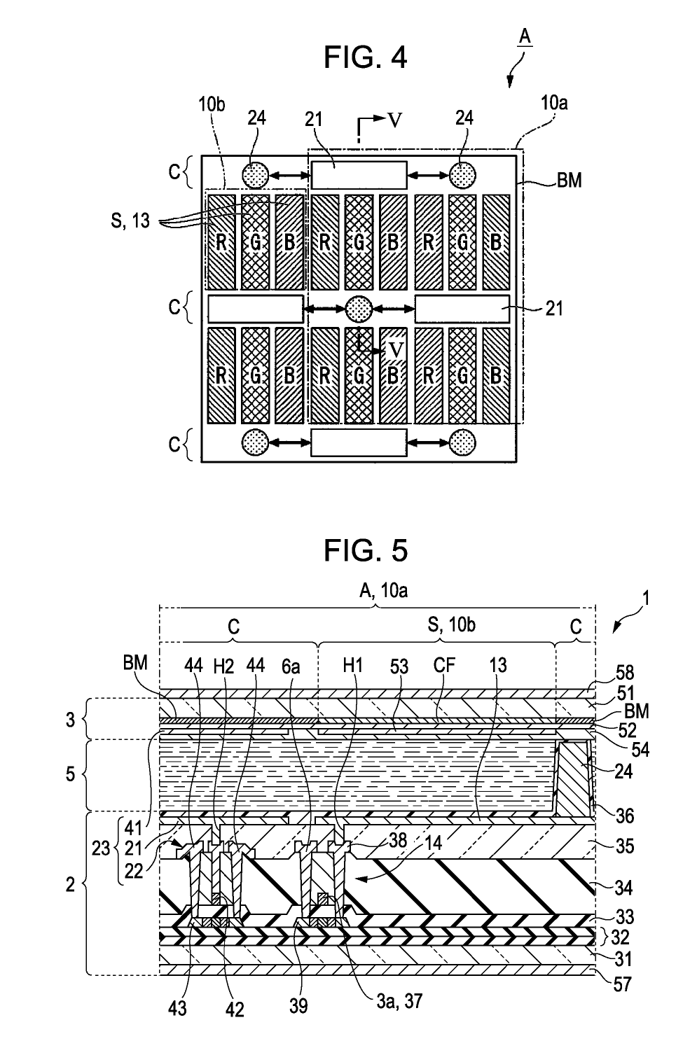

FIG. 4 is a schematic plan view showing a portion of a pixel arrangement on a device substrate. FIG. 5 is a cross-sectional view taken along line V-V of FIG. 4.

The liquid crystal device 1 according to the present embodiment is a liquid crystal device with a sensor electrode which is integrally formed. Three sub pixel areas for emitting colored light rays of red (R), green (G) and blue (B) configure one pixel and, hereinafter, a pixel area which is a minimum unit configuring the display is called a “sub pixel area S”. An area between the pixel areas is called an inter-pixel area C.

In the liquid crystal device 1 according to the present embodiment, touch determination units for detecting whether the image display area A is touched or not are in the inter-pixel area C shown in FIG. 4 in a matrix. The touch determination units convert touch information of the image display area A of a user into electrical signals and outputs detection signals of press information of a touch portion in the image display area A on the basis of a variation in capacitance due to pressing force between the sensor electrode 21 and the sensor electrode 41 of FIG. 5 or between the sensor electrode 21 and the pixel electrode 13.

Each of the touch determination units includes a touch determination portion 23 including a pair of sensor electrodes 21 and 41, which respectively face the different substrates 2 and 3, and a signal detection element 22, and the touch determination units are selectively and regularly arranged in a unit area 10a (for example, a range denoted by a dashed-dotted line of the drawing). That is, the liquid crystal device 1 according to the present embodiment has a touch panel structure, which determines whether the user touches on an icon displayed in the image display area A. Thus, it is possible to input data required when the liquid crystal device 1 is driven.

In the image display area A, cylindrical structures 24 for regulating the cell gap are arranged in a matrix. As shown in FIG. 4, in the unit area 10a, the number of sensor electrodes 21 (41) is equal to the number of cylindrical structures 24, and one of the sensor electrodes 21(41) or the cylindrical structures 24 is arranged with respect to one pixel area 10b. That is, the sensor electrodes 21 and the cylindrical structures 24 are alternately arranged in the row direction and the column direction of the pixels. Accordingly, in the overall image display area A, any sensor electrode 21 is at the same distance from at least two nearest cylindrical structures 24 at the same distance. For example, as denoted by an arrow of the drawing, the distances between the sensor electrodes 21 and the cylindrical structures 24 which are arranged nearest to the sensor electrodes 21 are equal. Accordingly, if the same pressing force for pressing the image display area A is applied, the cell thicknesses of all the sensor electrodes 21 equally vary and thus the touch position of the user can be detected with certainty.

Although the range denoted by the dashed-dotted line of FIG. 4 is the unit area 10a, the range is not limited thereto. If the number of sensor electrodes 21 is equal to the number of cylindrical structures 24, the range may be adequately changed.

The number of sensor electrodes 21 and the number of cylindrical structures 24 in the unit area 10a may be adequately set such that the uniformity of the cell thickness can be ensured and the low temperature foaming can be prevented.

As shown in FIG. 5, the device substrate 2 includes a substrate body 31 made of a light transmissive material such as glass, quartz or plastic, and an underlying insulating film 32, a gate insulating film 33, a first interlayer insulating film 34, a planarization film 35 and an alignment film 36, all of which are sequentially laminated on the inner surface of the substrate body 31.

As shown in FIG. 5, the scan lines 3a and the data lines 6a are formed on the substrate body 31 along boundary areas of the plurality of pixels. In the sub pixel area S which is two-dimensionally divided by the scan lines 3a and the data lines 6a, a semiconductor layer 39 provided on the inner surface of the underlying insulating film 32, a gate electrode 37 (a portion of the scan line 3a) provided on the inner surface of the gate insulating film 33, the data line 6a and the drain electrode 38 provided on the inner surface of the interlayer insulating film 34, and the pixel electrode 13 provided on the inner surface of the planarization film 35 are included. The data line 6a is connected to a source region of the semiconductor layer 39 and the drain electrode 38 is electrically connected to a drain region of the semiconductor layer 39. The pixel electrode 13 is connected to the drain electrode 38 through a contact hole H1 formed in the planarization film 35. The TFT 14 and the pixel electrode 13 connected to the TFT 14 are included in the sub pixel area S.

As shown in FIGS. 4 and 5, in the inter-pixel area C, the touch determination portion 23 which corresponds to a predetermined pixel and converts unevenness information of the touch portion of the user into an electrical signal is provided. The touch determination portion 23 includes the signal detection element 22 for outputting the detection signal of the touch information and the pair of sensor electrodes 21 and 41 for detecting the capacitance of the liquid crystal layer 5. The signal detection element 22 is a MOS transistor including a gate electrode 42, a polycrystalline silicon layer 43, and a source/drain electrode 44. The capacitance is variable capacitance in which the capacitance value of the liquid crystal layer 5 varies according to the pressing force of the user. The sensor electrode 21 is connected to the gate electrode 42 for controlling the switching of a selection transistor such that the variation in detection capacitance due to the touch of the user is sent to the signal detection element 22, and the variation in capacitance (pixel capacitance) can be sensed by the amplification of drain current flowing in a channel region of the polycrystalline silicon layer 43.

Although a 3-terminal transistor including the gate terminal (current control terminal), the source terminal (current output terminal) and the drain terminal (current input terminal) is used as the signal detection element 22 and the TFT 14 in the present embodiment, the invention is not limited thereto.

In order to manufacture the signal detection element 22 and the TFT 14 shown in FIG. 5, the underlying insulating film 32 such as silicon oxide is laminated on the substrate body 31, and an amorphous silicon film is formed and crystallized thereon, thereby forming the polycrystalline silicon layer 43 and the semiconductor layer 39. Next, the gate insulating film 33 is formed on the polycrystalline silicon layer 43 and the semiconductor layer 39, the gate electrode 42 is formed on the polycrystalline silicon layer 43, and the gate electrode 37 is formed on the semiconductor layer 39. Then, a dopant is implanted and diffused into the polycrystalline silicon layer 43 and the semiconductor layer 49 in self alignment so as to form the source/drain region. Next, the source/drain electrode 44, the data line 6a, the drain electrode 38 are formed on the first interlayer insulating film 34 so as to configure the signal detection element 22 and the TFT 14.

The planarization film 35 made of the light transmissive material is laminated, contact holes H1 and H2 are formed therein, the sensor electrode 21 is formed by a metal material such as Al, the pixel electrode 13 is formed by a light transmissive conductive material such as indium tin oxide (hereinafter, abbreviated to “ITO”), and the alignment film 36 made of a resin material such as polyimide is coated on the entire surface of the substrate, thereby forming the device substrate 2 according to the present embodiment. Here, the flatness of the polycrystalline silicon layer 43 and the semiconductor layer 39 are ensured by the planarization film 35 and a desired film thickness is obtained. The sensor electrode 21 may be formed simultaneously with the pixel electrode 13 using the same material as the pixel electrode 13.

The device substrate 2 according to the present embodiment includes the plurality of cylindrical structures 24 for holding the device substrate 2 and the counter substrate 3 which faces the device substrate. The cylindrical structures 24 are provided beneath the alignment film 36 and are, for example, formed of photosensitive resin. The cylindrical structures 24 are formed by patterning a resin film (not shown) formed on the planarization film 35 of the device substrate 2. By this material, it is possible to obtain the cylindrical structures 24 having suitable elasticity. The thickness of the resin film is set in order to ensure a desired cell thickness. The shape and the height of the cylindrical structures when viewed in a plan view and in a cross-sectional view are not important and are adequately selected by the size of the liquid crystal layer 5.

The pixel electrodes 13, the sensor electrodes 21(41) and the cylindrical structures 24 are arranged on the device substrate 2 so as not to two-dimensionally overlap each other.

In order to form a semiconductor device such as a transistor on the substrate body 31, the invention is not limited to the above-described method and, for example, using peel and transfer technology, the semiconductor device such as the transistor may be formed on the substrate body 31. If the peel and transfer technology is used, a cheap substrate having proper strength, such as a plastic substrate or a glass substrate, may be employed as the substrate body 31 and thus the mechanical strength of the liquid crystal device 1 can be increased.

Meanwhile, the counter substrate 3 includes a substrate body 51 made of a light transmissive material such as glass, quartz or plastic, color filters CF (R (red), G (green) and B (blue) which are sequentially formed on the substrate body 51, a black mask BM, a planarization film 52 formed on the entire surface of the substrate body 51 so as to cover the color filters CF and the black mask BM, the counter electrodes 53 formed on the planarization film 52, the sensor electrodes 41, and an alignment film 54 which covers the counter electrodes 53 and the sensor electrodes 41. Although the cylindrical structures 24 are formed on the planarization film 35 of the device substrate 2 in the present embodiment, the cylindrical structures may be formed on the planarization film 52 of the counter substrate 3.

In the pixel area (sub pixel area S), the color filters CF and the counter electrodes 53 are provided in correspondence with the pixel electrodes 13 of the device substrate 2. Here, the color filters CF are made of pigment and photosensitive transparent resin and the counter electrodes 53 are made of a light transmissive conductive material such as ITO, similar to the pixel electrodes 13.

In the inter-pixel area C, the sensor electrode 41 corresponding to the sensor electrode 21 of the device substrate 2 and the black mask BM are included. The sensor electrode 41 is made of a metal material such as Al, similar to the sensor electrode 21. As the light-shielding film, the black mask BM is formed on the substrate body 51 so as to the color filters CF.

In the liquid crystal panel, a pair of polarization plates 57 and 58 is provided such that the transmission axes thereof are substantially perpendicular to each other. Here, an optical compensation film (not shown) may be provided on the inner side or both sides of the polarization plates 57 and 58.

In the above-described configuration, the liquid crystal device 1 according to the present embodiment has electric capacity according to the thickness of the liquid crystal layer 5. For example, when the finger of the user touches the image display area A, the counter substrate 3 is curved by the pressing force, the capacitance of the liquid crystal layer 5 varies, and the pressing signal is output from the sensor electrode 21. When the signal detection element 22 is opened by the gate electrode 42, detection current decided by a gate potential is output from the signal detection element 22. The detection current is processed by the touch signal. The data required when the liquid crystal device 1 is driven can be directly input by detecting whether the finger of the user touches an icon displayed in the image display area A.

In the liquid crystal device 1 according to the present embodiment, in the unit area 10a of the image display area A, the number of cylindrical structures 24 is equal to the number of sensor electrodes 21(41) and the sensor electrodes 21 are at the same distance from the at least two nearest cylindrical structures 24 of the sensor electrodes 21. Accordingly, if the same pressing force is applied, the capacitance equally varies in every touch determination portion 23 and thus the touch position of the user can be detected with certainty. Since the sensor electrodes 21(41) and the pixel electrodes 13 are separately provided, it is possible to detect the variation in capacitance regardless of the display image. Since the touch is determined by detecting the variation in capacitance of the liquid crystal layer 5 by the touch determination portions 23 each including the pair of sensor electrodes 21 and 41, a wider temperature range can be used, compared with a contact type liquid crystal device for determining touch by bringing respective electrodes provided on a pair of substrates into contact with each other or a pressure-sensitive liquid crystal device for determining touch by pressure applied to the liquid crystal panel. That is, although the cell thickness varies by the temperature characteristics (thermal expansion coefficient) of the liquid crystal, the problem that the contact or the pressure cannot be detected does not occur and the touch of the user can be detected with certainty.

### Second Embodiment

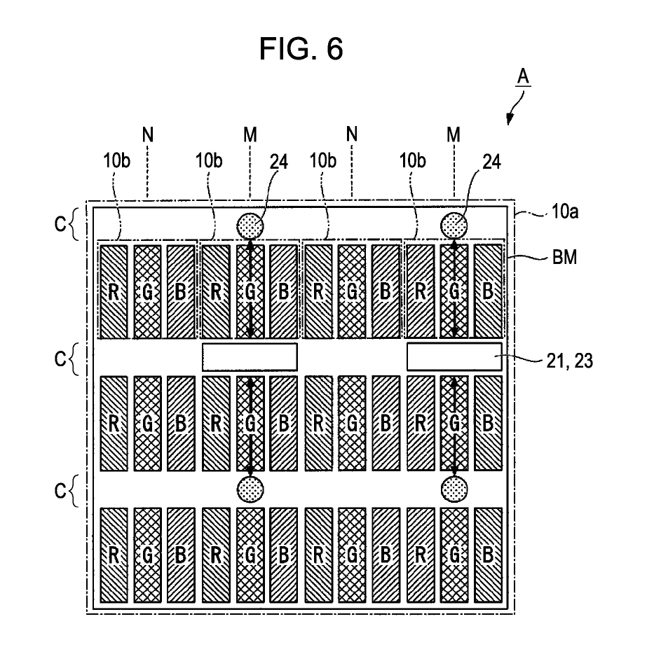

Next, a second embodiment of the invention will be described with reference to FIG. 6. FIG. 6 is a plan view showing the whole configuration of a liquid crystal device according to the second embodiment of the invention.

The basic configuration of the liquid crystal device according to the present embodiment is substantially equal to the first embodiment, but is different from the first embodiment in a method of arranging the cylindrical structures and the sensor electrodes in the unit area. In the following description, the arrangement of the cylindrical structures and the sensor electrodes in the unit area will be described in detail and the description of the common portions will be omitted. In the drawings used for the description, the common components to FIGS. 1 to 5 are denoted by the same reference numerals. In FIG. 6, the counter substrate is not shown.

In the present embodiment, in the unit area 10a of the image display area, the number of sensor electrodes 21 is equal to the number of cylindrical structures 24 and the sensor electrodes and the cylindrical structure are selectively and regularly arranged in the pixels arranged in the row direction and the column direction. In more detail, as shown in FIG. 6, the cylindrical structures 24 and the sensor electrodes 21 are alternately arranged with respect to the pixels in the arrangement of N-column pixels and any electrode is not arranged in the arrangement of M-column pixels. Accordingly, in the entire image display area A, any sensor electrode 21 is at the same distance from the at least two nearest cylindrical structures 24. That is, even in the present embodiment, the distances between the sensor electrodes 21 and the cylindrical structures 24 which are arranged nearest to the sensor electrodes 21 are equal (as denoted by an arrow of the drawing).

Although any one of the cylindrical structures 24 or the sensor electrodes 21 is not provided with respect to every pixel, since the sensor electrodes 21 are at the same distance from the cylindrical structures 24 nearest to the sensor electrodes 21 in the unit area 10a, if the same pressing force for pressing the image display area A is applied, the cell thicknesses of the sensor electrodes 21 equally vary. Accordingly, the touch position of the user in the image display area A can be detected with certainty.

The sensor electrodes 41 (see FIG. 5) formed at the side of the counter substrate 3 are provided according to the arrangement of the sensor electrodes 21 formed on the device substrate 2. This is similar in the following embodiments.

### Third Embodiment

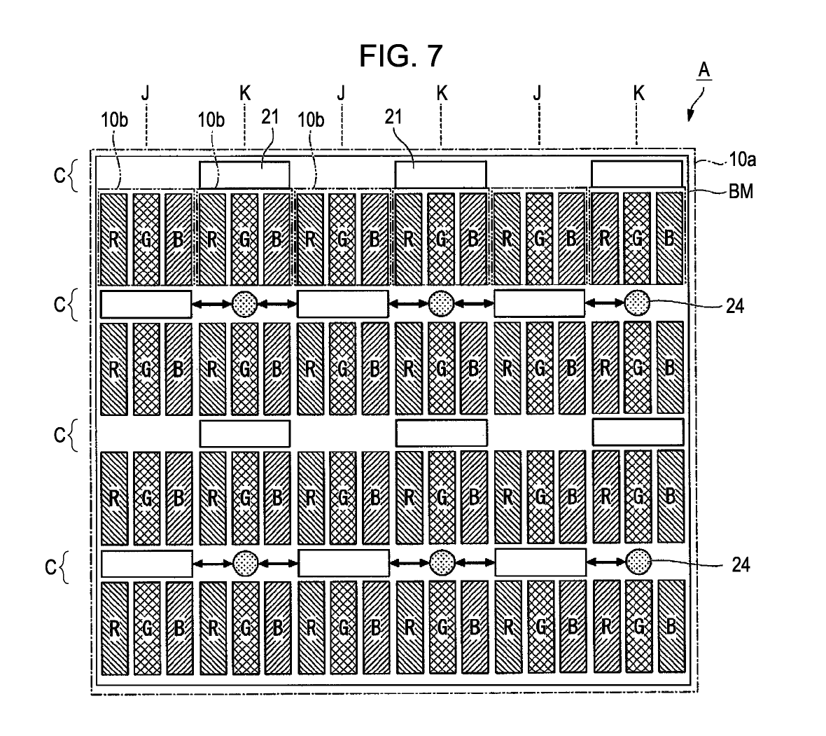

Next, a third embodiment of the invention will be described with reference to FIG. 7. FIG. 7 is a plan view showing the whole configuration of a liquid crystal device according to the third embodiment of the invention.

The basic configuration of the liquid crystal device according to the present embodiment is substantially equal to the first embodiment, but is different from the first embodiment in that the number of cylindrical structures is different from the number of sensor electrodes in the unit area. In the following description, the arrangement of the cylindrical structures and the sensor electrodes in the unit area will be described in detail and the description of the common portions will be omitted. In the drawings used for the description, the common components to FIGS. 1 to 5 are denoted by the same reference numerals. In FIG. 7, the counter substrate is not shown.

In the present embodiment, as shown in FIG. 7, in the unit area 10a of the image display area A, the number of cylindrical structures 24 is larger than the number of sensor electrodes 21. The sensor electrodes 21 are arranged at an interval of one pixel along a pixel column J and the sensor electrodes 21 and the cylindrical structures 24 are alternately arranged with respect to the pixels along a pixel column K. Here, the sensor electrodes 21 are arranged so as not to be adjacent to each other. In the entire image display area A, any sensor electrode 21 is at the same distance from the at least two nearest cylindrical structures 24. That is, even in the present embodiment, the distances between the sensor electrodes 21 and the cylindrical structures 24 which are arranged nearest to the sensor electrodes 21 are equal (as denoted by an arrow of the drawing).

By such a configuration, the variation in cell thickness of the sensor electrodes 21 near to the cylindrical structures 24 is relatively small, but the distances between the sensor electrodes 21 and the cylindrical structures 24 are equal and thus the touch position of the user can be detected. In the present embodiment, since the number of sensor electrodes 21 is different from the number of cylindrical structures 24 in the unit area 10a, the touch can be detected with certainty without depending on the use environment, by adequately setting the numbers in consideration of the uniformity of the cell thickness or the low temperature forming.

### Fourth Embodiment

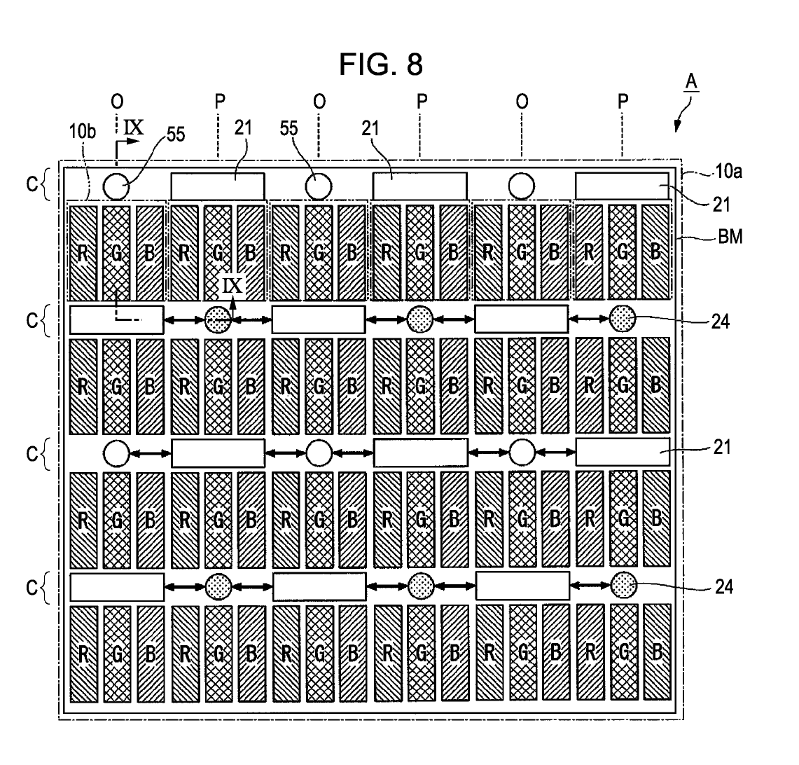

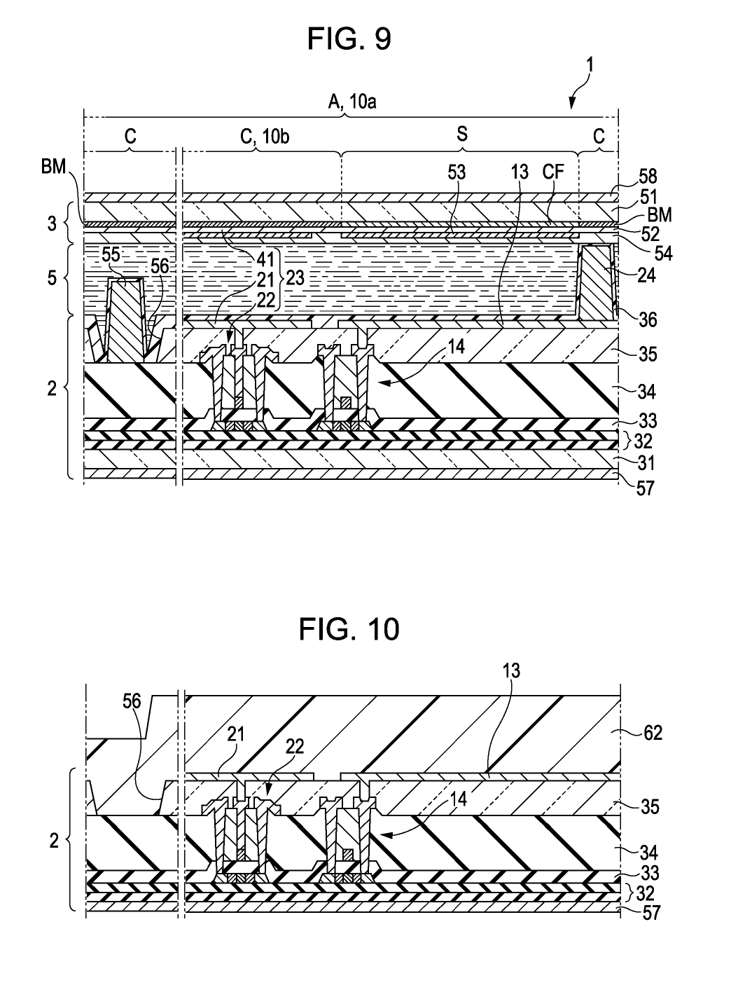

Next, a fourth embodiment of the invention will be described with reference to FIGS. 8 to 10. FIG. 8 is a plan view showing the whole configuration of a liquid crystal device according to the fourth embodiment of the invention. FIG. 9 is a cross-sectional view taken along line IX-IX of FIG. 8. FIG. 10 is a view showing a method of manufacturing a protrusion.

The basic configuration of the liquid crystal device according to the present embodiment is substantially equal to the first embodiment, but is different from the first embodiment in that protrusions having a height lower than that of the cylindrical structures 24 are provided in the unit area 10a. In the following description, the arrangement of the cylindrical structures 24, the sensor electrodes 21, and the protrusions 55 in the unit area 10a will be described in detail and the description of the common portions will be omitted. In the drawings used for the description, the common components to FIGS. 1 to 5 are denoted by the same reference numerals. In FIG. 8, the counter substrate is not shown.

In the present embodiment, as shown in FIG. 8, the sensor electrodes 21, the cylindrical structures 24 and the protrusions 55 having the height lower than the cylindrical structures 24 are selectively and regularly arranged in the unit area 10a with respect to the pixels so as not to two-dimensionally overlap one another. In the present embodiment, the number of sensor electrodes 21 is larger than the number of cylindrical structures 24 in the unit area 10a. The protrusions 55 and the sensor electrodes 21 are alternately arranged along a pixel column O with respect to the pixels and the sensor electrodes 21 and the cylindrical structures 24 are alternately arranged along a pixel column P with respect to the pixels. That is, as denoted by an arrow of the drawing, any cylindrical structure 24 and protrusion 55 are at the same distance from the sensor electrodes 21. Even in the present embodiment, the sensor electrodes 21 are not arranged in adjacent pixels.

As shown in FIG. 9, in the inter-pixel area C of the present embodiment, through-holes 56 which are formed in the planarization film 35 formed on the device substrate 2 simultaneously with contact holes H1 and H2 are provided and the interlayer insulating film 34 is exposed by the bottom of the planarization film. The protrusions 55 are arranged on the interlayer insulating film 34 in the through-holes 56. The black mask BM is provided on the inner surface of the counter substrate 3 corresponding to the protrusions 55.

The protrusions 55 are formed simultaneously with the cylindrical structures 24 by patterning a resin film 62 (FIG. 10) formed on the planarization film 35 and the pixel electrodes 13. Accordingly, the substantial configurations of the cylindrical structures 24 and the protrusions 55 are equal, but the cylindrical structures 24 formed on the planarization film 35 and the protrusions 55 formed in the through-holes 56 are at different distance from the counter substrate 3. That is, the cylindrical structures 24 and the protrusions 55 have different relative height positions of the device substrate 2 such that the upper surfaces of the cylindrical structures 24 are brought into contact with the inner surface (the surface of the liquid crystal layer 5 side) of the counter substrate 3 and the liquid crystal layer 5 is interposed between the upper surfaces of the protrusions 55 and the inner surface of the counter substrate 3. Since the protrusions 55 are provided for preventing the counter substrate 3 from being brought into contact with the device substrate 2 by the pressing force of the user, it is possible to protect the sensor electrodes 21(41), the pixel electrodes 13 and the counter electrodes 53 and prevent the alignment of the liquid crystal layer in the pixels from being disordered.

As described above, the protrusions 55 and the cylindrical structures 24 can be simultaneously formed of the same material and the through-holes 56 can be formed simultaneously with the contact-holes H1 and H2 formed in the planarization film 35. Accordingly, it is possible to obtain the protrusions 55 and the through-holes 56 for receiving the protrusions 55 without increasing the manufacturing process, improve product yield and reduce cost.

Although, in the present embodiment, the protrusions 55 are formed by the same shape of the cylindrical structures 24, the invention is not limited thereto and the protrusions 55 may be formed by other shapes. The protrusions 55 can prevent the sensor electrodes 21 and 41 from being brought into contact with each other by the pressing force of the user and prevent the sensor electrodes 21 and 41 from being brought into contact with each other even when the cell thickness varies according to the temperature of the use environment. Although the protrusions 55 and the cylindrical structures 24 are provided on the device substrate 2, through-holes (not shown) may be provided in the planarization film 52 of the counter substrate 3, the protrusions may be formed in the through-holes and the cylindrical structures may be provided on the planarization film 52.

Although the embodiments of the invention are described with reference to the accompanying drawings, the invention is not limited to the above-described embodiments and the above-described embodiments may be combined. It will be apparent to those skilled in the art that various modifications and variations can be made in the present invention without departing from the spirit or scope of the inventions. Thus, it is intended that the present invention covers the modifications and variations of this invention provided they come within the scope of the invention.

For example, in a semi-transmissive reflective liquid crystal device, the protrusions 55 may be arranged using a multi-gap structure. Since a resin layer for adjusting the thickness of the liquid crystal layer can be formed on a reflective layer made of Al in a reflective area of a pixel area, the thickness of the liquid crystal layer in a reflective display area is smaller than that of the liquid crystal layer in other areas (including a transmissive display area). Accordingly, the protrusions 55 may be arranged in an area (inter-pixel area) in which the resin layer is not provided and the cylindrical structure 24 may be arranged on the resin layer in the pixel area. Accordingly, since it is possible to save the effort of forming the through-holes 56 in which the protrusions 55 are formed, it is possible to improve product yield.

### Electronic Apparatus

Next, an electronic apparatus including the liquid crystal device described in the above-described embodiments will be described.

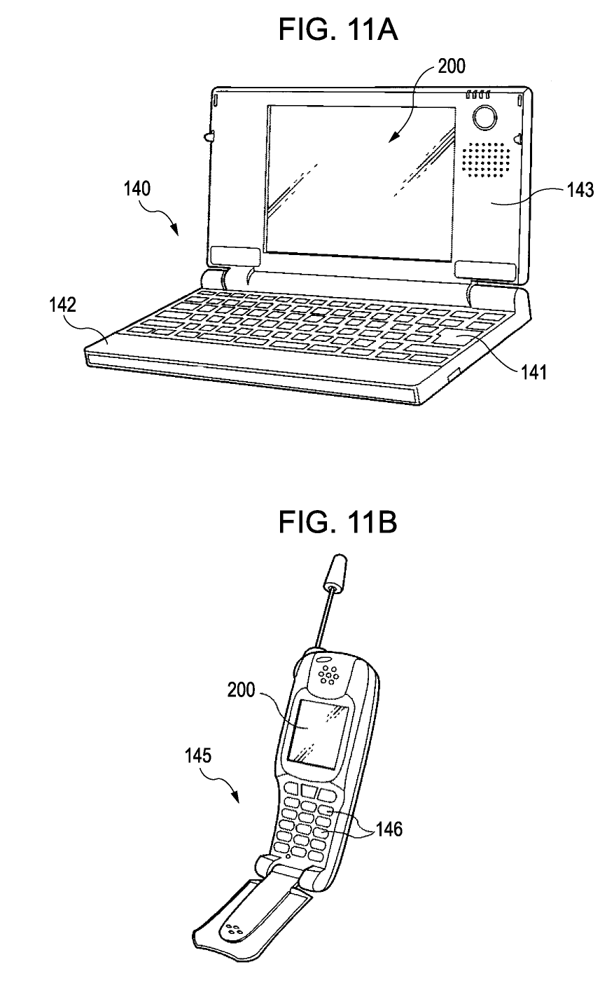

As shown in FIG. 11A, a mobile personal computer 140 which is an example of the electronic apparatus includes a main body 142 having a keyboard 141 and a display unit 143. The display unit 143 includes a display portion 200 made of the above-described liquid crystal device.

As shown in FIG. 11B, a mobile telephone 145 which is another example of the electronic apparatus includes a plurality of operation buttons 146 and a display portion 200 made of the above-described liquid crystal device.

The personal computer 140 and the mobile telephone 145 have the above-described liquid crystal device, it is possible to provide the personal computer 140 and the mobile telephone 145 capable of efficiently preventing a display defect from occurring in a pixel.

In addition to the above-described examples, the invention is applicable to a liquid crystal television set, a viewfinder-type or direct-view monitor type video tape recorder, a car navigation system, a pager, an electronic organizer, an electronic calculator, a word processor, a workstation, a videophone, a POS terminal, and an equipment including a touch panel. The liquid crystal device according to the invention can be suitably used as the display portion of the electronic apparatus.

What is claimed is:

1. A liquid crystal device including a liquid crystal layer interposed between a pair of substrates, the liquid crystal device comprising:
pixel electrodes which are arranged in an image display area, for displaying an image;
sensor electrodes which detect a variation in capacitance of the liquid crystal layer; and
cylindrical structures which maintain a gap between the pair of substrates and are arranged so as not to two-dimensionally overlap each other.

2. The liquid crystal device according to claim 1, wherein, in a unit area of the image display area, the number of cylindrical structures is equal to the number of sensor electrodes and the sensor electrodes are at the same distance from at least two cylindrical structures nearest to the sensor electrodes.

3. The liquid crystal device according to claim 1, wherein, in a unit area of the image display area, the number of sensor electrodes is larger than the number of cylindrical structures and the cylindrical structures are at the same distance from at least two sensor electrodes nearest to the cylindrical structures.

4. The liquid crystal device according to claim 1, wherein protrusions having a height lower than that of the cylindrical structures are provided in the image display area and the protrusion, the pixel electrodes, the sensor electrodes and the cylindrical structure are arranged so as not to two-dimensionally overlap one another.

5. The liquid crystal device according to claim 4, wherein, in a unit area of the image display area, the protrusions are at the same distance from at least two cylindrical structures nearest to the protrusions.

6. The liquid crystal device according to claim 4, wherein the cylindrical structures and the protrusions are formed of the same material.

7. The liquid crystal device according to claim 4, wherein a planarization film is provided on any one of the pair of substrates, the cylindrical structures are arranged on the planarization film, and the protrusions are arranged in concave portions provided in the planarization film.

8. The liquid crystal device according to claim 1, wherein the sensor electrodes, the cylindrical structures and the protrusions are regularly and selectively arranged in an arrangement direction of pixels.

9. The liquid crystal device according to claim 8, wherein an interval between the sensor electrodes and an interval between the cylindrical structures are equal to or greater than a pixel pitch.

10. The liquid crystal device according to claim 8, wherein the sensor electrodes and the cylindrical structures are alternately arranged in a row direction and a column direction of pixels.

11. The liquid crystal device according to claim 8, wherein:
the sensor electrodes and the cylindrical structures are alternately arranged in any one of a row direction and a column direction of pixels, and
the sensor electrodes and the protrusions are alternately arranged in the other one of the row direction and the column direction of the pixels.

12. An electronic apparatus comprising the liquid crystal device according to claim 1.
